(19) United States
(12) Patent Application Publication
(10) Pub. No.: US 2007/0102346 A1
(43) Pub. Date: May 10, 2007

(54) Device for absorbing grease, oil and fat from food products

(76) Inventors: Peter Cordani, Palm Beach Gardens, FL (US); Anne Cordani, Palm Beach Gardens, FL (US)

Correspondence Address: MCHALE & SLAVIN, P.A., 2855 PGA BLVD, PALM BEACH GARDENS, FL, 33410, US

(21) Appl. No.: 11/271,399

(22) Filed: Nov. 9, 2005

(51) Int. Cl. B01D 39/00

(52) U.S. Cl. 210/483; 210/503; 210/464

(57) ABSTRACT

The instant invention is a device for absorbing excess oil, grease and fat from liquid food products. The device has a porous outer layer completely enclosing an inner layer resembling a conventional tea bag. The inner layer of the device contains an oil, grease and fat absorbing material. When the device is placed into a liquid food product that contains unwanted hazardous liquid, the device will absorb the excess. The device can then be easily removed from the liquid food product by simply grabbing a string attached to the device that remains out of the food product by an anchoring means.

### FIELD OF THE INVENTION

This invention relates generally to the absorption of oil, grease and fat and specifically to a device for absorbing oil, grease and fat from liquid food products.

1. Background of the Invention

Conventional cooking of food presents a problem in the collection and disposal of excess oil, grease and fat. In addition, some of the expelled oil, grease and fat remains on the surface of the food product, adding to the amounts of sodium and cholesterol in the cooked food. Medical evidence warns of the potential health hazards associated with excess sodium, fat, and cholesterol in the diet.

A traditional method of removing excess oil, grease and fat consists of straining the excess harmful liquids from the food product. However, the hot oil, grease and fat can splash causing an additional mess and possibly harm to a person. Further, the oil, grease and fat must be disposed of and the container used cleaned, jobs most people would avoid given the opportunity.

Another method of removing excess oil, grease and fat from soups, gravies and the like is through the utilization of an ordinary spoon or ladle. However, this method is time consuming and it is difficult to do a thorough job. Further, should only a small amount of the unwanted substance be present, such as in soup, it is not practical to strain, drain or otherwise remove the oil by conventional methods.

Thus, what is needed in the art is a process for absorbing excess oil, grease and fat from liquid food products that doesn't require straining and is easily disposed.

2. Prior Art U.S. Pat. No. 5,093,176 discloses a device and method for absorbing excess oil from food products but its practical application is limited to solid foods.

### SUMMARY OF THE INVENTION

The instant invention is a device for absorbing excess oil, grease and fat from liquid food products by placing the device, which contains an absorbing material, into a liquid food product until the unwanted liquids are absorbed. The device is then removed and disposed of.

The device is composed of two layers, a non-hazardous absorbing material inner layer completely enclosed by a porous outer layer. The porous outer layer is composed of a material that permits the passage of oil, grease and fat such as filter paper, tea bag paper, or a wettable polyolefin composition. The inner layer is composed of a non-woven, fibrous, oil-absorbent polyolefin, polyamide, polycarbonate, or polyester. In the preferred embodiment, the inner layer is a polyolefin and in the most preferred embodiment, the polyolefin is a polypropylene.

In the preferable embodiment, there is a string with an anchor means attached to the device. The string allows the device to be circulated within a food product and serves as a means for removal and disposal of the device from the food product. The preferred embodiment is packaged in various sizes and shapes to accommodate different quantities of oil, grease and fat.

Accordingly, it is an objective of the instant invention to disclose an improved device for removing oil, grease and fat from liquid food products.

It is a further objective of the instant invention to disclose a device for absorbing oil, grease and fat from liquid food products.

It is still a further objective of the instant invention to disclose a oil, grease and fat absorption device for liquid food products that is easily removable from the liquid and easily disposable.
It is yet another objective of the instant invention to disclose a device for removing oil, grease and fat from liquid food products that is inexpensive, and easily manufactured, stored, and disposed of
Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 depicts a diagrammatic view of the device.

FIG. 2 depicts a cross section view of the outer and inner layers.

### DETAILED DESCRIPTION OF THE FIGURES

The instant invention is a device for absorbing excess oil, grease and fat from liquid food products. The device has a porous outer layer completely enclosing an inner layer. The inner layer of the device contains an oil, grease and fat absorbing material. When the device is placed into a liquid food product that contains unwanted hazardous liquid, the device will absorb the excess. When the desired absorption has been reached, the device can then be easily removed from the food product by simply gripping a string attached to the device that remains out of the liquid food product by an anchoring means.

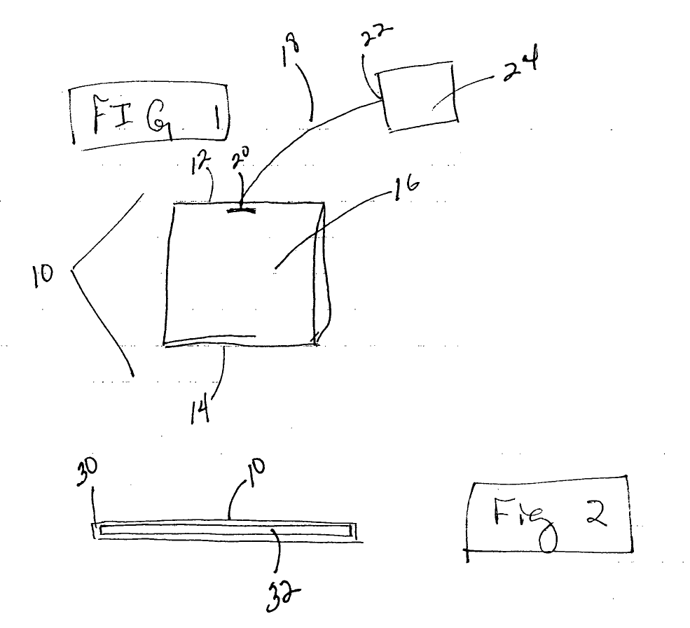

Now referring to FIG. 1, the device has an outer layer 10 having a top 12, a bottom 14, four sides 16, and an inner cavity. The outer layer 10 is a porous material that permits the passage of oil, grease and fat. For example, suitable porous materials include, but are not limited to, filter paper, tea bag material such as paper or cheese cloth, and wettable polyolefin compositions. In the preferred embodiment, the device has at least one string 18 with a first end 20 and second end 22. The first end 20 of the string 18 is attached to the top 12 of the device.

The manner of affixing the string 18 to the outer layer 10 (or each string, if more than one is used) includes any method which is effective and convenient, including the use of knots, staples, glue, threading, and the like. The method of affixing the string 18 to the outer layer 10 may permit the string 18 to slide through the outer layer 10 or the string 18 may be anchored to the outer layer 18 at one or quantities of oil, grease and fat.

It is to be understood that while the instant invention has been illustrated and described in certain forms, it is not to be limited to the specific forms or arrangements of parts herein described and shown. It will be apparent to those skilled in the art that various changes may be made without departing from the scope of the invention and the invention is not to be considered limited to what is shown in the drawings and described in the specification.

What is claimed is:

1. An oil, grease and fat absorbing device for food products comprising;
a porous outer layer defining an inner cavity;
a non-hazardous absorbent inner layer material, said inner layer residing within said inner cavity and completely enclosed by said outer layer.

2. The device of claim 1 wherein said outer layer is filter paper.

3. The device of claim 1 wherein said outer layer is tea bag material.

4. The device of claim 1 wherein said outer layer is a wettable polyolefin composition.

5. The device of claim 4 wherein said polyolefin is isotactic polypropylene.

6. The device of claim 1 wherein said inner layer is non-hazardous, non-woven absorbent layer of polyolefin, polyamide, polycarbonate, or polyester.

7. The device of claim 6 wherein said polyolefin is polypropylene.

8. The device of claim 1 further comprising a string with a first and second end, said first end of said string attached to said outer layer.

9. The device of claim 8 further comprising an anchor means, said anchor means attached to said second end of said string.

10. The device of claim 9 wherein said anchor means is a tab, tag, or button.

11. The device of claim 1 wherein said porous outer layer resembles a conventional tea bag.
